(19) United States
(12) Patent Application Publication
(10) Pub. No.: US 2025/0307178 A1
(43) Pub. Date: Oct. 2, 2025

(54) ETHERNET SWITCH, VEHICLE, AND STORAGE MEDIUM

(71) Applicant: TOYOTA JIDOSHA KABUSHIKI KAISHA, Toyota-shi (JP)

(72) Inventor: Tomoya ARAKAWA, Tokyo (JP)

(21) Appl. No.: 19/018,492

(22) Filed: Jan. 13, 2025

(30) Foreign Application Priority Data
Mar. 26, 2024 (JP) 2024-049647

(51) Int. Cl. G06F 13/10

(52) U.S. Cl. CPC G06F 13/102

(57) ABSTRACT

An Ethernet switch connected to a plurality of on-board electronic control units each having at least one processor and having a plurality of ports connecting the respective processors and configured to receive data from each processor and transmit data to a destination processor comprises a controller configured to determine target data from the received data based on a predetermined condition, and a buffer configured to hold the target data. The controller is configured such that, when the target data is determined, the target data is held in the buffer until communication with the destination processor is permitted, when communication with the destination processor is permitted, the target data is transmitted to the destination processor, and when data different from the target data is received before communication with the destination processor is permitted, the received data is not held in the buffer.

### CROSS-REFERENCE TO RELATED APPLICATION

This application claims priority to Japanese Patent Application No. 2024-049647 filed on Mar. 26, 2024, incorporated herein by reference in its entirety.

### BACKGROUND

### 1. Technical Field

The present disclosure relates to an Ethernet switch, a vehicle, and a program.

### 2. Description of Related Art

Japanese Unexamined Patent Application Publication No. 2015-227143 (JP 2015-227143 A) discloses an in-vehicle Electronic Control Unit (ECU). A first Micro Controller Unit (MCU) and a second MCU included in the electronic control unit can communicate with each other. The first MCU is connected to an in-vehicle Local Area Network (LAN) and has a relay function of relaying data transmitted from the in-vehicle LAN to the second MCU. The second MCU 11 receives data transmitted from the in-vehicle LAN through the first MCU. The first MCU continues to hold data to be transmitted to the second MCU until activation of the second MCU can be confirmed for a predetermined period of time immediately after a power supply is turned on when the data transmitted from the in-vehicle LAN is to be relayed to the second MCU.

### SUMMARY

According to the electronic control unit described in JP 2015-227143 A, there is a concern that the capacity of data to be held may exceed the capacity of a buffer of the electronic control unit and it may not be possible to hold important data. The present disclosure provides a technique capable of appropriately holding data in communication between electronic control units.

An Ethernet switch according to an aspect of the present disclosure is an Ethernet switch that is connected to a plurality of in-vehicle electronic control units each having at least one processor, has a plurality of ports to which each processor is connected, and is configured to receive data from each processor and transmit the data to a destination processor.
The Ethernet switch includes
a controller configured to determine target data based on a predetermined condition from data received from each processor at the time of activation of each electronic control unit, and
a buffer configured to hold the target data,
wherein
the controller is configured
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.

A vehicle according to another aspect of the present disclosure includes a plurality of in-vehicle electronic control units each having at least one processor, and an Ethernet switch having a plurality of ports to which each processor is connected, the Ethernet switch being configured to receive data from each processor and transmit the data to a destination processor,
wherein
the Ethernet switch includes
a controller configured to determine target data based on a predetermined condition from data received from each processor at the time of activation of each electronic control unit, and
a buffer configured to hold the target data,
and
the controller is configured
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.

A non-transitory storage medium storing a program according to another aspect of the present disclosure
causes an Ethernet switch to operate, the Ethernet switch being connected to a plurality of in-vehicle electronic control units each having at least one processor, the Ethernet switch having a plurality of ports to which each processor is connected, the Ethernet switch being configured to receive data from each processor and transmit the data to a destination processor.
The Ethernet switch includes a buffer, and
the program causes the Ethernet switch to operate
to determine target data based on a predetermined condition from data received from each processor when each electronic control unit is activated,
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.

According to the present disclosure, a technique capable of appropriately holding data in communication between electronic control units is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of a vehicle including an Ethernet switch according to an embodiment;

FIG. 2 is a diagram for explaining time charts of respective processors at the time of ignition ON;

FIG. 3 is a block-diagram illustrating an exemplary configuration of an Ethernet switch; and

FIG. 4 is a flowchart illustrating an operation of the Ethernet switch.

### DETAILED DESCRIPTION OF EMBODIMENTS

Hereinafter, an embodiment of the disclosure will be described with reference to the drawings.

### Configuration of Vehicle

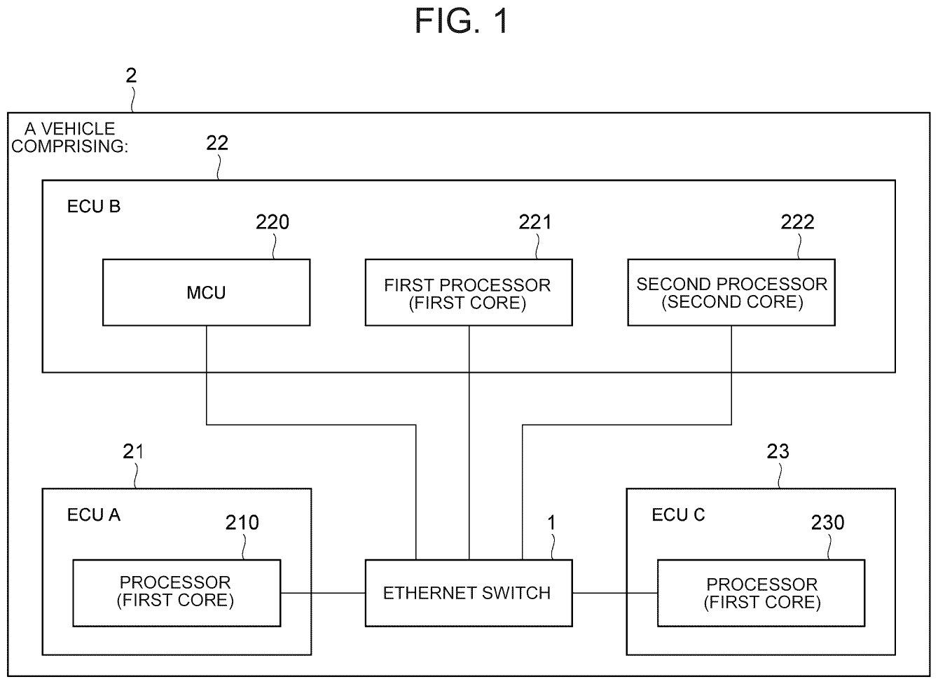

FIG. 1 is a block diagram illustrating an example of a configuration of a vehicle including an Ethernet switch according to an embodiment. As shown in FIG. 1, the Ethernet switch 1 is mounted on the vehicle 2 as an example. The vehicle 2 may be a vehicle driven by a driver or an autonomous vehicle.

The Ethernet switch 1 is connected to a plurality of ECU. In the embodiment shown in FIG. 1, the Ethernet switch is connected to the first ECU 21 (ECUA), the second ECU 22 (ECUB), and the third ECU 23 (ECUC). ECU is an electronic control unit having Central Processing Unit (CPU), Read Only Memory (ROM), Random Access Memory (RAM), Controller Area Network (CAN) communication circuitry, etc. ECU includes at least one processor. For example, the first ECU 21 comprises a processor 210 having a first core. A core is a CPU core and is a device that processes instructions. The first core is a device capable of dealing with a process requiring real-time performance.

The second ECU 22 includes a MCU 220, a first processor 221 having a first core, and a second processor 222 having a second core. MCU 220 is a chip equipped with a CPU core-like a processor. The second core is a device capable of handling a process in which real-time performance is not required more than that of the first core. The third ECU 23 comprises a processor 230 having a first core. The Ethernet switch 1 has a plurality of ports connecting the respective processors, and is configured to receive data from the respective processors and transmit data to the destination processor. Hereinafter, a case in which data is communicated in a packet format will be described as an example.

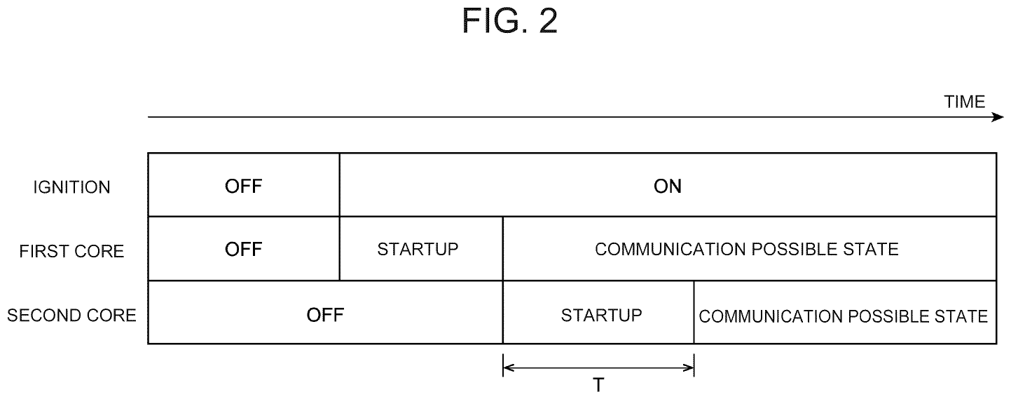

The Ethernet switch 1 operates in consideration of the activation timing of each connected processor. FIG. 2 is a diagram for explaining time charts of the processors at the time of ignition ON. As shown in FIG. 2, although the processor having the first core starts starting at the timing when the ignition of the vehicle 2 is turned ON from OFF, the processor having the second core remains in OFF without starting the starting. Then, when the processor having the first core completes the activation and becomes ready for communication, the processor having the second core starts the activation. Thereafter, the processor having the second core completes the activation and becomes ready for communication. As described above, there is a period T during which the processor having the first core is in a communicable state and the processor having the second core is in an activated state (a communication disabled state). In the period T, even if a packet is transmitted from the processor having the first core to the processor having the second core, the packet cannot be received by the processor having the second core, and thus the packet 15 is discarded. Therefore, the Ethernet switch 1 temporarily stores a packet including important data in its own buffer until the processor having the second core is in a communicable state.

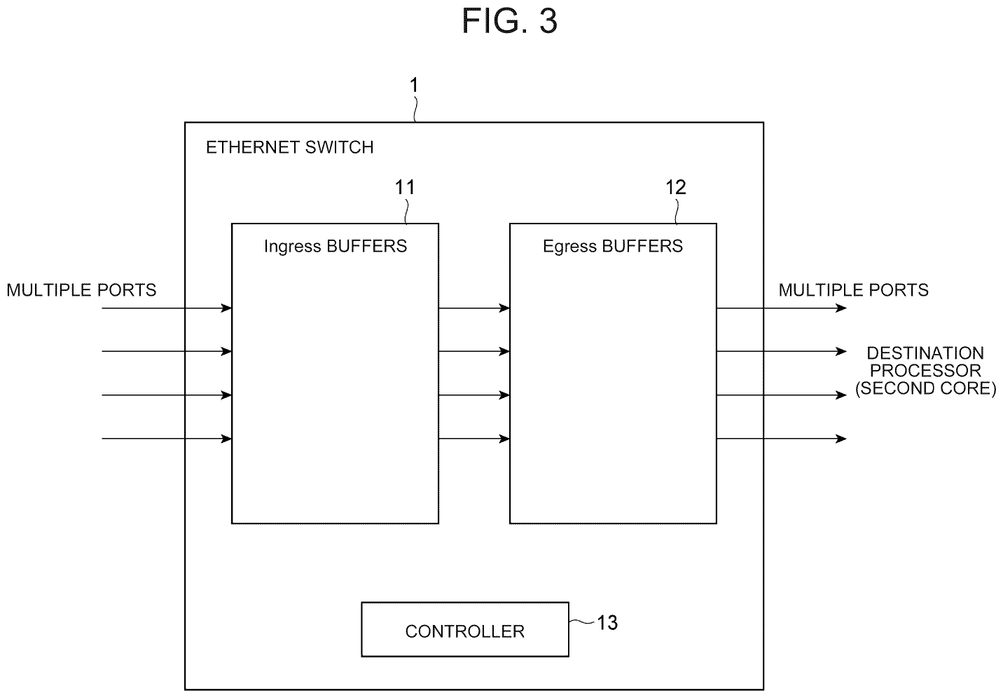

FIG. 3 is a block diagram illustrating an example of a configuration of an Ethernet switch. As illustrated in FIG. 3, the Ethernet switch 1 includes an Ingress buffer 11 (an exemplary buffer), an Egress buffer 12, and a controller 13. Ingress buffer 11 and Egress buffer 12 are storage media. Performance such as the capacity and data transfer rate of Ingress buffer 11 and Egress buffer 12 may be the same or different.

Ingress buffers 11 are connected to respective ports of the Ethernet switch 1, and have a function of holding packets received from the respective ports. That is, Ingress buffers 11 are storage media used at the time of receiving packets. Egress buffer 12 is connected to Ingress buffer 11 and temporarily holds the packets output from Ingress buffer 11 for output to the destination processor. In other words, Egress buffers 12 are storage media used at the time of transmitting packets.

The controller 13 has a function of controlling the operation of the Ethernet switch 1, and is, for example, a Large Scale Integration (LSI). The controller 13 performs a function of controlling the configuration of Ingress buffers 11 by using a script or the like. A configuration is a configuration. The controller 13 controls the configuration so that Ingress buffers 11 store only the required packets.

For example, the controller 13 is configured to determine a target packet (an exemplary target packet) based on a predetermined criterion from among packets received from the processors at the time of activation of each ECU. The predetermined condition is a condition set in advance for determining the target packet. The predetermined condition includes, for example, information indicating a target port. In this case, the controller 13 is configured to determine, as the target packet, a packet received at the target port or a packet to be transmitted to the target port based on the information indicating the target port. For example, since the processor having the first core has a short startup time, the port to which the processor having the first core is connected is set as the target port. For example, since the processor having the second core has a long startup time, the port to which the processor having the second core is connected is set as the target port.

The predetermined requirement may include at least one of a source IP address, a destination IP address, and a protocol. The controller 13 is configured to determine, as the target packet, a packet that matches the source IP address, the destination IP address, or the protocol. The source IP address, the destination IP address, and the protocol may be obtained using, for example, an Access Control List (ACL) function that is standardized in the Ethernet switch 1. For example, if the source IP address indicates a processor having a first core and the destination IP address indicates a processor having a second core, then the above-described period T will be present. Therefore, such a packet is a target packet. Note that the predetermined condition may be appropriately set according to the capacity of the packet to be held, and may be set to accept all packets when there is a margin in the buffer.

When the target packet is determined, the controller 13 causes Ingress buffers 11 to hold the target packet. As a specific example, the controller 13 controls the configuration of Ingress buffers 11 to hold the target packets.

The controller 13 causes Ingress buffers 11 to hold target packets until communication with a processor having a second core (an exemplary destination processor) is permitted. If the processor having the first core of the transmission source is in a communicable state and the processor having the second core is not activated, the controller 13 determines that communication with the processor having the second core is not permitted.

The controller 13 detects the activation state of the processor having the second core by any of the following methods. The first approach is to monitor the Ethernet link state of a processor having a second core. When the processor with the second core is activated, a link to the network port to the processor with the second core is established. The controller 13 detects that the processor having the second core is activated by detecting the establishment of the link. The second approach is to monitor event-based notifications. After the processor having the second core is activated, a notification is made from the processor having the second core to the Ethernet switch according to UDP protocol. The controller 13 detects that the processor having the second core is activated by detecting the notification.

The controller 13 is configured to prevent the received packet from being held in Ingress buffers 11 when a packet differing from the target packet is received prior to the communication with the processor having the second core being permitted. Not being held in Ingress buffers 11 includes discarding packets (data). As a result, only high-priority data is held in Ingress buffers 11.

When communication with the processor having the second core is permitted, the controller 13 causes the target packet held in Ingress buffer 11 to be outputted to Egress buffer 12. The controller 13 transmits the target packet in Egress buffers 12 to the processor having the second core. Thereafter, the controller 13 sets the configuration of Ingress buffers 11 to the steady-state. For example, the steady state configuration may be set such that all packets are not stored.

### Ethernet Switch Operation

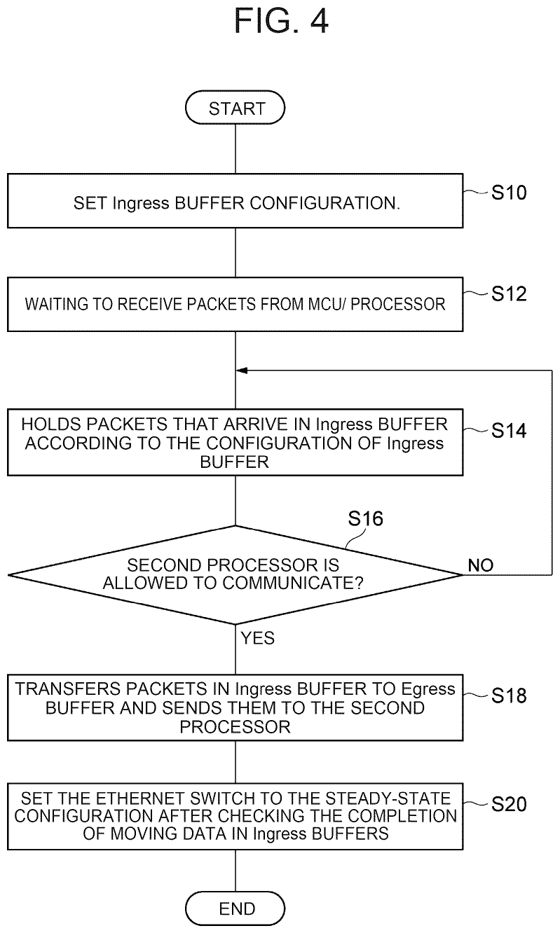

FIG. 4 is a flowchart illustrating an operation of the Ethernet switch. The flow chart shown in FIG. 4 is executed by the Ethernet switch 1, for example, at the timing of the ignition ON.

As shown in FIG. 4, first, the Ethernet switch 1 sets the configuration of Ingress buffers 11 as a S10. Here, as an example, the configuration is set such that the packet transmitted to the second processor 222 of FIG. 1 is the target packet. Subsequently, the Ethernet switch 1 waits for reception of a packet from MCU or the processor as a S12. When a packet is received, the Ethernet switch 1 determines a target packet according to the configuration of Ingress buffers 11, and holds the target packet. For example, only packets transmitted to the second processor 222 are held in Ingress buffers 11.

Next, the Ethernet switch 1 determines, as an S16, whether the communication of the second processor 222 is permitted. When it is determined that the communication of the second processor 222 is not permitted (S16: NO), the Ethernet switch 1 returns to S14 and repeatedly holds the packets and determines that the communication is permitted. Note that the Ethernet switch 1 may include logic that forcibly leaves the repetitive loop when a predetermined period of time has elapsed.

When it is determined that the communication of the second processor 222 is permitted (S16: YES), the Ethernet switch 1 moves, as a S18, the packets in Ingress buffer 11 to Egress buffer 12. Then, the Ethernet switch 1 transmits a packet to the second processor 222.

As an S20, the Ethernet switch 1 sets the steady configuration of the Ethernet switch 1 after the completion of the moving of data in Ingress buffers 11. That is, the Ethernet switch 1 returns the configuration of Ingress buffers 11 to the steady-state configuration. When S20 ends, the flow chart shown in FIG. 4 ends.

### SUMMARY OF EMBODIMENTS

In the Ethernet switch 1, when the target packet is determined, the target packet is held in Ingress buffers 11 until communication with the processor having the second core is permitted. When communication with the processor having the second core is permitted, the target packet is transmitted to the processor having the second core. When a packet different from the target packet is received before the communication with the processor having the second core is permitted, the received packet is not held in the buffer. In this way, in the communication between processors having a difference in startup time, only packets to be transmitted to the processor having the second core with a slow startup time are held at the time of startup, so that packet loss at the time of startup can be avoided.

While exemplary embodiments have been described above, various omissions, substitutions, and changes may be made without being limited to the exemplary embodiments described above. For example, the functions of the Ethernet switch 1 described above may be provided as a program, or may be provided in a storage medium storing the program.

What is claimed is:

1. An Ethernet switch connected to a plurality of in-vehicle electronic control units each having at least one processor, the Ethernet switch having a plurality of ports to which the processor is connected, the Ethernet switch being configured to receive data from each processor and transit the data to a destination processor, the Ethernet switch comprising:
a controller configured to determine target data based on a predetermined condition from the data received from each processor when each electronic control unit is activated; and
a buffer configured to hold the target data; wherein
the controller is configured
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.

2. The Ethernet switch according to claim 1, wherein:
the predetermined condition includes information indicating a target port; and
the controller is configured to determine the data received by the target port as the target data based on the information indicating the target port.

3. The Ethernet switch according to claim 1, wherein:
the predetermined condition includes at least one of a transmission source IP address, a destination IP address, and a protocol; and
the controller is configured to determine the data that matches the predetermined condition as the target data.

4. A vehicle comprising:
a plurality of in-vehicle electronic control units each having at least one processor; and
an Ethernet switch having a plurality of ports to which each processor is connected, the Ethernet switch being configured to receive data from each processor and transmit the data to a destination processor, wherein
the Ethernet switch includes
a controller configured to determine target data based on a predetermined condition from the data received from each processor when each electronic control unit is activated, and
a buffer configured to hold the target data, and
the controller is configured
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.

5. A non-transitory storage medium storing a program that causes an Ethernet switch to operate, the Ethernet switch being connected to a plurality of in-vehicle electronic control units each having at least one processor, the Ethernet switch having a plurality of ports to which each processor is connected, the Ethernet switch being configured to receive data from each processor and transmit the data to a destination processor, wherein:
the Ethernet switch includes a buffer; and
the program causes the Ethernet switch to operate
to determine target data based on a predetermined condition from the data received from each processor when each electronic control unit is activated,
to cause the buffer to hold the target data until communication with the destination processor is permitted in a case where the target data is determined,
to transmit the target data to the destination processor in a case where communication with the destination processor is permitted, and
not to cause the buffer to hold received data in a case where data that is different from the target data is received before communication with the destination processor is permitted.
